(19) United States
(12) Patent Application Publication
(10) Pub. No.: US 2018/0309508 A1
(43) Pub. Date: Oct. 25, 2018

(54) Providing Continuous Two-Way High-Speed Data Transfer for Leo Based Satellites

(71) Applicant: U.S.A. AS REPRESENTED BY THE ADMINISTRATOR OF NASA, WASHINGTON, DC (US)

(72) Inventors: Curtis R. Regan, Norfolk, VA (US); Stephen J. Horan, Poquoson, VA (US)

(21) Appl. No.: 15/958,408

(22) Filed: Apr. 20, 2018

Related U.S. Application Data
(60) Provisional application No. 62/488,250, filed on Apr. 21, 2017.

(51) Int. Cl. H04B 7/185

(52) U.S. Cl. CPC H04B 7/18528; H04B 7/18502; H04B 7/18584; H04B 7/18513

(57) ABSTRACT

Various embodiments may provide a system for continuous two-way high-speed data transfer for satellites, such as Low Earth Orbit (LEO) based satellites and/or Medium Earth Orbit (MEO) based satellites.

### CROSS-REFERENCE TO RELATED PATENT APPLICATION(S)

This patent application claims the benefit of and priority to U.S. Provisional Application No. 62/488,250, filed on Apr. 21, 2017, the contents of which are hereby incorporated by reference in their entirety.

### STATEMENT REGARDING FEDERALLY SPONSORED RESEARCH OR DEVELOPMENT

The invention described herein was made by employees of the United States Government and may be manufactured and used by or for the Government of the United States of America for government purposes without the payment of any royalties thereon or therefore.

### BACKGROUND OF THE INVENTION

Low Earth Orbit (LEO) satellites conventionally only receive commands and transmit data while over a ground terminal. The ground contact time is typically short, such as about 10 minutes. There are typically gaps in data transfer to cooperating ground terminals, anywhere from 60 minutes to 24 hours. LEO satellites must currently store their data on-board to account for these gaps and plan for extra storage capability in case one ground contact opportunity is missed. These constraints currently limit LEO satellites to low data throughput and require large on-board data storage capabilities, increasing the cost of the systems. For example, smaller LEO satellites, such as Cubesats, are currently severely limited to low data rates, such as 10 kbps or less, and have fewer ground terminals due to budget constraints and low signal strength. The current state of the practice requires greater connectivity support and the ability for users to have “anytime, anywhere” access to their satellites and data.

Medium Earth Orbit (MEO) satellites also have similar operating characteristics to LEO satellites in the form of limited ground visibility each orbit and the need to store data between contacts with cooperating ground terminals.

Satellite constellations are arrangements of cooperating satellites placed in Low Earth Orbit (LOE) or Medium Earth Orbit (MEO) in one or more orbital planes spaced around the Earth having one or more satellites in each plane. To provide coverage continuity, constellation designers space the orbital planes and the numbers of satellites within the plane to provide at least one, and often more than one, satellite with visibility of a single geographic point over the Earth. Improved data connectivity results from having one or more satellites in one or more orbital planes visible to a communications user at each moment. The orbital motions bring successive satellites in the various planes into the user's view according to the laws of orbital mechanics.

### BRIEF SUMMARY OF THE INVENTION

Various embodiments may provide a system for continuous, two-way, high-speed data transfer for Low Earth Orbit (LEO) based or Medium Earth Orbit (MEO) based satellites, referred to herein as a UserSat, utilizing a data router satellite, referred to herein as a SkyRouter, to sustain data transfers and provide additional services.

Various embodiments of the SkyRouter include constellations of similar satellites operated by a service provider entity or a collection of compatible satellites operated by differing entities and working cooperatively to provide services. The primary function of the SkyRouter is to provide data connectivity services for user satellites. Various embodiments of these services include connectivity between the user satellite and ground data service points, connectivity between the user satellite and other user satellites, and connectivity with other cooperating SkyRouters for data routing. Various embodiments of the SkyRouter may provide additional data services such as data storage and data processing for use by orbiting satellites or ground users. Various embodiments may include a satellite communication system having multiple SkyRouters to provide services, at least one UserSat receiving those services, and a series of Earth-based ground terminals in communication with the SkyRouter. Services may be through a defined contract or, as available, on the services spot market. The SkyRouters may be configured to communicate with one another and with ground terminals using Internet protocols to send and receive data. The UserSats may establish two-way, high-speed data connections with the SkyRouters using Internet protocols and may transmit and receive data to/from ground-based computing devices via the SkyRouters and ground terminals. Various embodiments may provide a modem for a UserSat configured to operate according to Internet protocols to send and receive data with other UserSats.

The various embodiments also apply to Mid Earth Orbit (MEO) based satellites for data services and data routing.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a system diagram of a system of Low Earth Orbit (LEO) satellites, UserSats, suitable for use with the various embodiments;

FIG. 1B is a communication block diagram of components of the system of FIG. 1A;

FIG. 2A is a communication flow diagram between of components of the system of FIG. 1A;

FIG. 2B is a packet diagram of a packet suitable for use in various embodiments in the data flows of FIG. 2A; and

FIG. 3 is a component block diagram of a LEO satellite UserSat suitable for use with the various embodiments.

### DETAILED DESCRIPTION OF THE INVENTION

For purposes of description herein, it is to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The word “exemplary” is used herein to mean “serving as an example, instance, or illustration.” Any implementation described herein as “exemplary” is not necessarily to be construed as preferred or advantageous over other implementations.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

As used herein, the term “computing device” refers to any one or all of cellular telephones, smart phones, personal or mobile multi-media players, personal data assistants (PDAs), laptop computers, personal computers, tablet computers, smart books, palm-top computers, embedded computers, wireless electronic mail receivers, multimedia Internet enabled cellular telephones, wireless gaming controllers, satellite or cable set top boxes, streaming media players, smart televisions, digital video recorders (DVRs), and similar electronic devices which include a programmable processor and memory and circuitry for performing the operations described herein.

As used herein, the term “SkyRouter” refers to any data services satellite providing connectivity between user satellites and ground data service points, connectivity between any one user satellite and other user satellites, and connectivity with other cooperating SkyRouters for data routing. A SkyRouter may provide additional data services such as data storage and data processing for use by orbiting satellites or ground users. The data storage and data processing may be distributed across multiple SkyRouters.

As used herein, the term “UserSat” refers to either a Low Earth Orbit (LEO) or Medium Earth Orbit (MEO) satellite obtaining data transmission, storage, or processing services from a SkyRouter as part of a data transaction with a ground entity or another LEO or MEO satellite.

As used herein, the term “Internet Protocols” are packet-based data networking protocols used to encapsulate data for transmission over the network and provide necessary source and destination identification, data flow management, data flow accounting, error detection or correction, and other data services to enable delivery between the intended source and destination. The SkyRouters may use information contained in the protocol fields to assist in necessary routing, accounting, and connection management operations to successfully sustain the data services they provide.

As used herein, the term “space-to-space” refers to intersatellite communication utilizing any of the various electromagnetic signaling methods between two orbiting satellites without sending the signal to a ground system for relay between the satellites. For UserSats, this usually provides the advantage of shorter propagation time than routing through ground terminals. For LEO UserSats communicating with SkyRouters in a higher orbit, this provides the advantage of a lower probability of interception by unauthorized users listening at a ground terminal.

As used herein, the term “constellation of SkyRouters” comprises a constellation of similar satellites operated by a service provider entity to provide user services or a collection of compatible satellites operated by differing entities and working cooperatively to provide user services.

As used herein, the term “Software Defined Radio” (SDR) refers to the embodiment of the satellite data modem and transceiver functions in a device composed of discrete radio components, computing processors, including ASICs, FPGAs, DSPs, and general purpose computing elements, memory, and software that permits selection and control of radio transmission characteristics such as frequency band or transmission power, data protocol characteristics such as Internet Protocol options selection, data flow management, data error detection or correction management, and other support functions to sustain and manage data flow. The addition of Internet Protocol functionality to the basic SDR radio functions is sometimes called Software Defined Networking (SDN). Applications for SDR/SDN technologies may be in traditional radio frequency bands. Additionally, similar functioning optical communications systems may provide equivalent functions to SDR system. In those optical cases, the modem and transceiver functions may be called Optical SDNs or similar terms and optical radio components may also be used in the various embodiments.

Various embodiments may provide a system for continuous two-way high-speed data transfer for Low Earth Orbit (LEO) based satellites also known as UserSats. Various embodiments may include a system having a constellation of SkyRouter router satellites in orbits above at least one LEO satellite and a series of Earth-based ground terminals in communication with the router satellites. In various embodiments, the ground terminals may be fixed-location ground terminals and/or may be mobile ground terminals. The router satellites may be configured to communicate with one another and with ground terminals using Internet Protocols to send and receive data. The LEO satellites may establish two-way high-speed data connections, such as 50 Mbps connections or greater, with the router satellites using Internet Protocols and may transmit and receive data to/from ground-based computing devices via the router satellites and ground terminals. In various embodiments, the LEO satellites may transmit their data over a space-to-space link to the router satellites in Earth orbit. In various embodiments, the LEO satellites may be assigned Internet Protocol (IP) addresses, or other data or service-based routing identifier, and the LEO satellites may communicate with the network of router satellites using the assigned IP address.

Various embodiments may include a satellite communication system having multiple SkyRouters to provide services, at least one UserSat receiving those services, and a series of Earth-based ground terminals in communication with the SkyRouter. Services may be through a defined contract or, as available, on the services spot market. The SkyRouters may be configured to communicate with one another and with ground terminals using Internet protocols to send and receive data. The UserSats may establish two-way, high-speed data connections with the SkyRouters using Internet protocols and may transmit and receive data to/from ground-based computing devices via the SkyRouters and ground terminals. Various embodiments may provide a modem for a UserSat configured to operate according to Internet protocols to send and receive data with other UserSats. For example, the modem may be encapsulated as part of a Software Defined Radio (SDR) communications device configured in a 10 cm×10 cm×1 cm form factor to fit within a 3 Unit (3U) CubeSat (10 cm×10 cm×30 cm) form factor.

In various embodiments, data communications may utilize standard data networking protocols to perform operations of the various embodiment communications methods. Embodiment networks may support connectionless and connection-oriented protocols, for example based on the end user needs. The protocols may be those found in the terrestrial data networks and international space communications networks. The embodiment data networks may support point-to-point data flow as well as managed end-to-end data flow. The embodiment data networks may support encrypted and non-encrypted data links. For example, data may flow in a connectionless manner from source to destination using the standard TCP/IP suite of data packets similar to electronic mail messages. Managed, connection-oriented data flow may be achieved with protocols such as the file transfer protocol (ftp) or Delay Tolerant Networking (DTN) (also known as Disruption Tolerant Networking). Data flow may be based on a specific source-destination method, a subscription-based method, or a streaming-based method. This is not to preclude other packet protocols being used in various embodiments, such as those from the Consultative Committee for Space Data Systems or from next-generation Internet development that may use techniques such as Content-Oriented Networking or other techniques based on data content and not only on addressing. As used herein, the term Internet Protocols (IP) is used as the representative for all such protocols.

Various embodiments of the data communications packets used in the network communications may include at least two of three principal partitions. The first partition may be the packet header that is composed of information to assist with routing the packet and understanding the packet format. Depending upon the protocol-specific definition, this may include fields such as the routing information, for example the source and destination addresses of the data, protocol-specific information, for example the protocol version number, security characteristics, data priority, and packet management information, for example, packet accounting information and information to understand how the data are arranged in the packet payload. Protocols may divide this header into a primary and secondary header or have a single header entity. The second partition may be the packet payload that contains the data for the user application. This data may be a single entity, for example a telecommand or a set of telemetry values, or it may be a larger data set spanning multiple packets, for example file data larger than the protocol constraint for a single packet or continuous streaming data. The third entity, which is an option in various embodiments, may be a packet trailer. Packet trailers may be for error detection or correction, echoing telecommand data, or other packet accounting information dictated by the protocol.

Various embodiments may provide a modem for a LEO satellite configured to operate according to suites of Internet Protocols to send and receive data with other satellites. For example, the modem may be encapsulated as part of a Software Defined Radio (SDR) communications device configured in a 10 cm×10 cm×1 cm form factor to fit within a 3 Unit (3U) CubeSat (10 cm×10 cm×30 cm) form factor.

Various embodiments may enable data flow to be continuous, instead of data transmission only occurring over a ground terminal in conventional systems, because the constellation of SkyRouter router satellites may always be visible to the LEO satellites and at least one router satellite may always be in line-of-sight of the LEO satellites. The continuous ability to transmit data may reduce the data storage requirements for LEO satellites when compared with conventional LEO satellite data storage requirements. As the various embodiments may operate according to Internet Protocols, additional LEO satellites may be added to the system merely by assigning those LEO satellites IP addresses or other relevant routing information based on the service type. In various embodiments, as the LEO satellites transmit over space-to-space links to send data to the router satellites, there may be little to no detection of a transmission signature of the LEO satellites at the Earth's surface or from other satellites in Earth orbit. Various embodiments may enable faster satellite update times and may eliminate or reduce gaps in data reception from LEO satellites. This may be of advantage in various industries, such as weather monitoring services, as there may be no gaps in the data. In various embodiments, the LEO satellites may include advanced computing environments that provide quick-look data processing of the telemetry data of the LEO satellites to reduce the overall data volume sent from the LEO satellites. In various embodiments, LEO satellites may send data to ground terminals on Earth for storage in distributed cloud storage systems. In various embodiments, the SkyRouter router satellites may offer data processing, data storage, and Cloud services as part of their overall communications capabilities.

Current LEO satellites transmit data in a nadir direction to their own ground terminals. However, LEO satellites of the various embodiments transmit data over a space-to-space link into the constellation of SkyRouter router satellites. In various embodiments, the data users will not need to have a formal ground terminal to receive data and will use the point of presence interface from the router satellite service provider to permit fixed-location services and to allow mobile users to have “anytime, anywhere” access. In various embodiments, LEO satellites and router satellites may use the same communication channels to transmit data. The presence of many router satellites in orbit may ensure that there may always be at least one, and often many more, router satellites in line of sight communication with embodiment LEO satellites. Multiple router satellites in communication may provide several levels of redundancy or relieve congestion on the data links.

While various embodiments may be discussed in reference to LEO satellites, LEO satellites are merely one type of satellites, and the LEO satellites may be replaced in the various embodiments with other type satellites, such as Medium Earth Orbit (MEO) satellites, etc., without departing from the spirit or scope of the invention. As such, the various embodiment techniques related to using LEO satellite constellations for data transfer described herein equally apply to similarly-configured MEO satellite constellations.

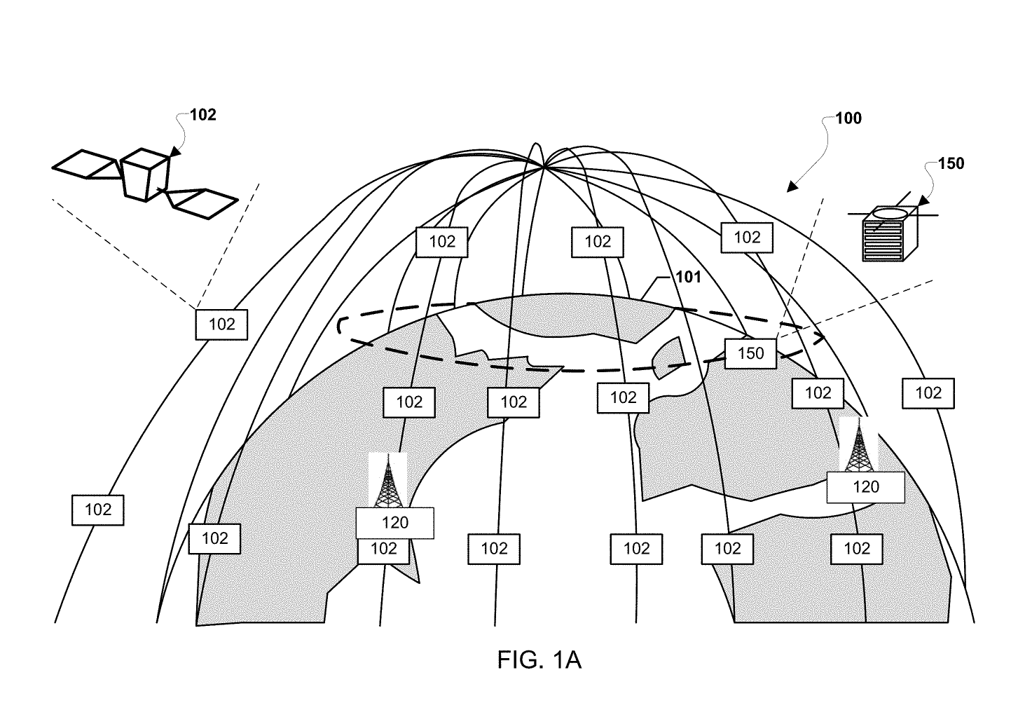

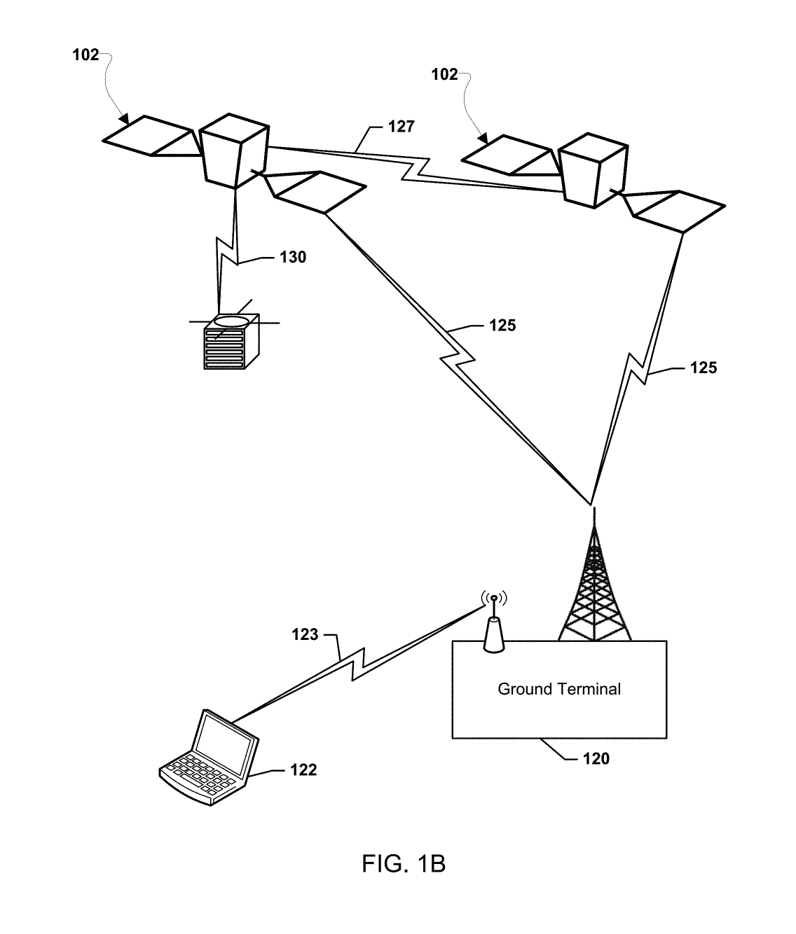

FIG. 1A is a system block diagram of a satellite communication system (i.e., a data relay system) 100 including a constellation of SkyRouter router satellites 102. FIG. 1A illustrates a portion of the Earth 101 and the constellation of router satellites 102 orbiting the Earth 101. Each of the SkyRouter router satellites 102 may be configured to communicate with one another and ground terminals 120 according to Internet Protocols. For example, the constellation of SkyRouter router satellites 102 may be satellites from the company OneWeb, or similar satellite constellation companies, providing Internet service to anywhere in the world. Together the constellation of SkyRouter router satellites 102 may provide coverage of the entire Earth 101. The constellation of SkyRouter router satellites 102 may include a large number of SkyRouter router satellites 102, such as one hundred SkyRouter router satellites 102 or more. A close-up view of one SkyRouter router satellite 102 of the constellation of SkyRouter router satellites 102 is illustrated in FIG. 1A. The SkyRouter router satellites 102 may provide high-speed (e.g., 50 Mbps or greater) two-way data communications with ground terminals 120 on Earth 101. The two-way data communication may be established according to Internet Protocols. Via connections, such as Internet service and/or cellular connections, to the ground terminals 120, ground based computing devices may be provided access to the SkyRouter router satellites 102. In various embodiments, computing devices may establish connections to the ground terminals 120 on Earth 101. In various embodiments, ground terminals may be fixed-location or mobile, as required by the application.

A close-up view of LEO satellite UserSat 150 is also illustrated in FIG. 1A. LEO satellite UserSat 150 may be any type satellite, such as a Cubesat, the International Space Station (ISS), a high flying unmanned aerial vehicle (UAV), a scientific research balloon, a launching rocket system, etc., in a LEO or in a flight path above the Earth's surface below the constellation of SkyRouter router satellites 102 (i.e., between the Earth 101 and the SkyRouter router satellites 102). While one LEO satellite is illustrated in FIG. 1A, any number of LEO satellites 150 may be in orbit below the constellation of SkyRouter router satellites 102. The LEO satellites 150 may establish two-way communications according to Internet Protocols with one or more SkyRouter router satellites 102.

FIG. 1B illustrates aspects of the system 100 illustrated in FIG. 1A, including the SkyRouter router satellites 102, a LEO satellite UserSat 150, a ground terminal 120, and a user's computing device 122. With reference to FIGS. 1A and 1B, the user's computing device 122 may establish a connection 123 to the ground terminal 120, such as a wired or wireless connection (e.g., cellular, Wi-Fi, Ethernet, etc.). The ground terminal 120 may establish a respective connection 125 with each router satellite 102. In some embodiments the connections 125 may be line of sight limited and connections between any given router satellite and the ground terminal 120 may be periodically established and disestablished. In various embodiments, more than one ground terminal 120 may be present on the surface of the Earth 101 and the SkyRouter router satellites 102 may establish different connections 125 with different ground terminals 120 as connections become possible. The SkyRouter router satellites 102 may also establish connections 127 with one another. The LEO satellite UserSat 150 may establish a connection 130 with one or more of the SkyRouter router satellites 102. The connection 130 may be established with any router satellite 102 that is available for the LEO satellite UserSat 150 to connect with at a given time. As the constellation of SkyRouter router satellites 102 may always be visible to the LEO satellite UserSat 150, the connection 130 may be established at any time. Via the connections 123, 125, 127, and 130 the various devices, such as the SkyRouter router satellites 102, ground terminal 120, LEO satellite UserSat 150, and user's computing device 122 may exchange data with one another. In some embodiments, the connections 125, 127, and 130 may be two-way high data rate wireless connections established according to Internet Protocols.

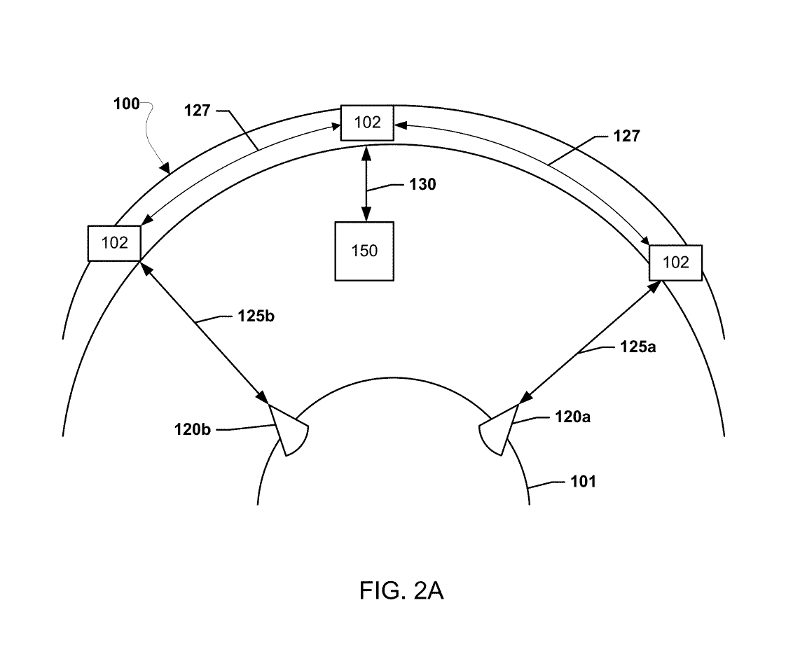

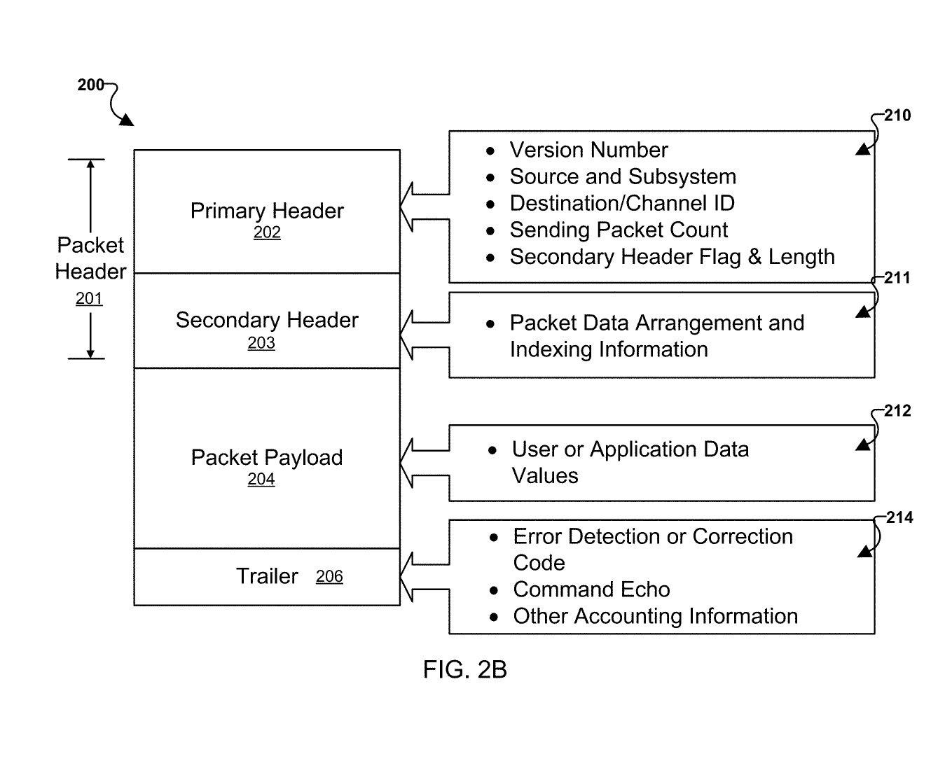

FIG. 2A is a communication flow diagram between components of the system 100 according to various embodiments. With reference to FIGS. 1A-2A, the LEO satellite UserSat 150 may transmit data over a space-to-space link toward a SkyRouter router satellite 102 in the constellation of SkyRouter router satellites 102 via connection 130. The router satellite 102 receiving the data from the LEO satellite UserSat 150 may not be currently over a ground terminal 120 and may route the data via connection 127 to another router satellite 102 that is over a ground terminal 120. In various embodiments, the data routed by the LEO satellite UserSat 150 to the SkyRouter router satellites 102 may include routing identifiers indicating the data's intended destination, such as ground terminal 120. The SkyRouter router satellites 102 may utilize the routing identifiers to route the data towards its intended destination. The router satellite 102 may send the data to the ground terminal 120 via connection 125 and the ground terminal 120 may send the data on to a user's computing device, such as user's computing device 122 (FIG. 1B). In a similar manner, data (or commands) may be sent to the LEO satellite UserSat 150 from a user's computing device, such as user's computing device 122 (FIG. 1B) by sending the information to a ground terminal 120 that sends a transmission to the router satellite 102 over the ground terminal 120. The router satellite 102 over the ground terminal 120 may forward the data to the router satellite 102 connected to the LEO satellite UserSat 150. The data (or commands) sent to the LEO satellite UserSat 150 may include the routing identifier of the LEO satellite UserSat 150 embedded therein enabling the SkyRouter router satellites 102 to route the data (or commands) toward the LEO satellite UserSat 150.

The ability of the SkyRouter router satellites 102 to route data between one another may enable any satellite (e.g., a LEO satellite UserSat 150 or a satellite of another satellite system) in communication with one router satellite 102 to send/receive telemetry and telecommand data to/from the Earth 101, even when that satellite (e.g., LEO satellite UserSat 150 or a satellite of another satellite system) is not overhead of one of its own ground terminals. The distributed nature of the SkyRouter router satellites 102 enables telemetry and telecommand data to be sent to any router satellite 102 and forwarded among the SkyRouter router satellites 102 to the destination satellite (e.g., LEO satellite UserSat 150 or a satellite of another satellite system). By embedding in the data to be sent routing identifiers for the satellite to receive the telemetry and telecommand data (e.g., LEO satellite UserSat 150 or a satellite of another satellite system), the SkyRouter router satellites 102 may route the telemetry and telecommand data to the destination satellite (e.g., LEO satellite UserSat 150 or a satellite of another satellite system). In this manner, an antenna need not be pointing at that satellite (e.g., LEO satellite UserSat 150 or a satellite of another satellite system) to send data to that satellite (e.g., LEO satellite UserSat 150 or a satellite of another satellite system). In a similar manner, the satellite (e.g., LEO satellite UserSat 150 or a satellite of another satellite system) can route data via the routers 102 to its ground terminals using their respective routing identifiers. This enables “anytime, anywhere” type access between ground terminals and satellites (e.g., LEO satellite UserSat 150 or a satellite of another satellite system) through the SkyRouter router satellites 102.

The various embodiments may be suitable for small satellite (smallsat), those satellites typically under 100 kg mass, applications as used by Government Agencies, Universities, and commercial companies. Smallsats typically have a low data throughput due to low power capability and limited ground contacts. CubeSats are a typical embodiment of a smallsat architecture. The various embodiments may provide an internal modem or Software Defined Radio (SDR) to connect smallsats continuously to the SkyRouter router satellites. As such, the various embodiments may provide higher data rates, continuous data transfer, higher data throughput, and greatly reduced on-board data storage requirements. The various embodiments may be suitable for LEO satellite applications that require continuous data transfer and faster update times, such as weather monitoring, and may provide un-gapped data transfers to such LEO satellites. The various embodiments may also provide the ISS with another method of high-speed (e.g., such as 50 Mbps or greater) data transfer as a backup for current systems or to add increased data capacity.

The various embodiments may enable unique applications. For example, a high-flying UAV may use an embodiment modem or Software Defined Radio (SDR) to establish a connection to the SkyRouter router satellites as the primary or secondary method of communication to/from the UAV. As such, a switch between line of sight and non-line of sight communications with the UAV may not be necessary. LEO satellites according to the various embodiments would no longer have gaps in their downlinks as they orbit between ground terminals. Continuous data downlinks may be enabled, thereby providing additional security benefits.

FIG. 2B is a packet diagram for encapsulating the data flow of FIG. 2A according to an embodiment. FIG. 2B illustrates a packet 200 encapsulating data elements 210, 211, 212, and 214 in different partitions 201, 204, and 206. With reference to FIGS. 1A-2B, the packet 200 may include three principal partitions, the packet header 201, the packet payload 204, and the packet trailer 206. The packet header 201 may include information to assist with routing the packet 200 and understanding the packet 200 format. The packet header 201 may be split into a primary header 202 and a secondary header 203. The primary header may include data elements 210, such as version number, source and subsystem information, destination/channel ID, sending packet count, and secondary header flag and length information. The secondary header 203 may include data elements 211, such as packet data arrangement and indexing information. Depending upon the protocol-specific definition, the data elements 210 and 211 in the packet header 201 may include fields such as the routing information, for example the source and destination addresses of the data, protocol-specific information, for example the protocol version number, security characteristics, data priority, and packet management information, for example, packet accounting information and information to understand how the data are arranged in the packet payload. The second partition may be the packet payload 204 that may include contains data elements 212 including the data for the user application. This data 212 may be a single entity, for example a telecommand or a set of telemetry values, or it may be a larger data set spanning multiple packets, for example file data larger than the protocol constraint for a single packet or continuous streaming data. The third entity, which may be optional, may be a packet trailer 206. Packet trailers 206 may include data elements 214 for error detection or correction, echoing telecommand data, or other packet accounting information dictated by the protocol.

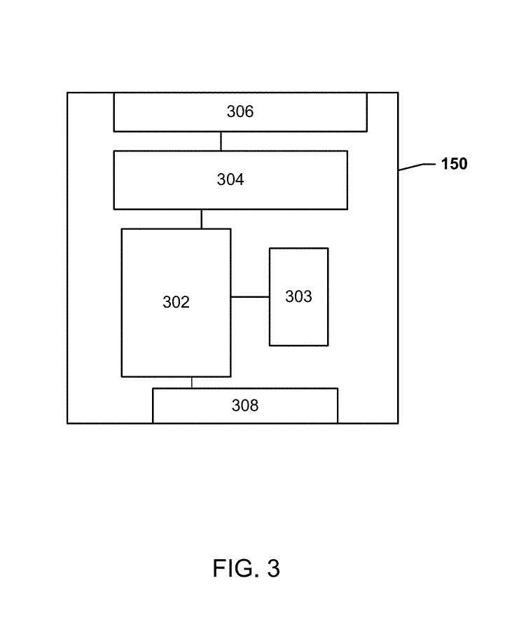

FIG. 3 illustrates components of a LEO satellite UserSat 150 suitable for use with the various embodiments. With reference to FIGS. 1A-3, the LEO satellite UserSat 150 may be any type satellite, such as a Cubesat, as described above. A LEO satellite UserSat 150 will typically include a processor 302 coupled to a memory 303, such as a volatile memory or a nonvolatile memory. Additionally, the LEO satellite UserSat 150 may have one or more antennas 306 for sending and receiving electromagnetic radiation that may be connected to a wireless data link modem and/or transceiver 304 coupled to the processor 302. In various embodiments, the one or more antennas 306 may be any type antennas, such as steerable antennas developed by Isotropic Systems. In various embodiments, the wireless data link modem and/or transceiver 304 may establish connections with other satellites, such as SkyRouter router satellites 102 according to Internet Protocols. In various embodiments, the wireless data link modem and/or transceiver 304 may be a smallsat network-agile modem. The LEO satellite UserSat 150 may also include instrument payloads 308 that may generate data for transmission via the wireless data link modem and/or transceiver 304. The LEO satellite UserSat 150 may also include a power source, such as a battery, solar cell, etc., connected to the processor 302, wireless data link modem and/or transceiver 304, and/or other components of the LEO satellite UserSat 150 to provide power to those components. In various embodiments, the modem and/or transceiver 304 may be embodied in a Software Defined Radio (SDR) architecture.

The processor 302 may be any programmable microprocessor, microcomputer or multiple processor chip or chips that can be configured by software instructions (applications) to perform a variety of functions, including the functions of the various embodiments described above. In some LEO satellites 150, multiple processors may be provided, such as one processor dedicated to wireless communication functions and one processor dedicated to running other applications. Typically, software applications may be stored in the internal memory before they are accessed and loaded into the processor 302. The processor 302 may include internal memory sufficient to store the application software instructions. In many LEO satellites 150, the internal memory may be a volatile or nonvolatile memory, such as flash memory, or a mixture of both. For the purposes of this description, a general reference to memory refers to memory accessible by the processor 302 including internal memory or removable memory plugged into the device and memory within the processor 302 itself.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A satellite communication system, comprising:
a constellation of SkyRouter router satellites configured to communicate with one another according to an Internet Protocol; and
at least one UserSat satellite,
wherein the UserSat satellite is configured to establish a two-way high-speed data connection according to an Internet Protocol with any one of the SkyRouter router satellites in the constellation of SkyRouter router satellites.

2. The system of claim 1, wherein the UserSat satellite is a Medium Earth Orbit (MEO) satellite.

3. The system of claim 1, wherein the UserSat satellite is in orbit between the constellation of SkyRouter router satellites and Earth.

4. The system of claim 3, wherein the UserSat satellite is a Low Earth Orbit (LEO) satellite.

5. The system of claim 4, further comprising:
at least one ground terminal configured to communicate with the constellation of SkyRouter router satellites according to an Internet Protocol,
wherein the UserSat satellite is configured to send data to a ground-based computing device via the two-way high-speed data connection, the SkyRouter router satellites, and the ground terminal.

6. The system of claim 5, wherein the two-way high-speed data connection is a 50 Mbps or greater data connection.

7. The system of claim 5, wherein the data is sent from a first one of the SkyRouter router satellites to a second one of the SkyRouter router satellites before being sent to the ground terminal.

8. The system of claim 5, wherein the data is sent from the LEO satellite over a space-to-space data link toward the constellation of SkyRouter router satellites.

9. The system of claim 8, wherein the LEO satellite is a smallsat and includes a networking-agile modem that is used to establish the two-way high-speed data connection.

10. The system of claim 8, wherein the LEO satellite is assigned an Internet Protocol (IP) address and is configured to receive data from the constellation of SkyRouter router satellites using the IP address.

11. The system of claim 10, wherein a routing identifier is embedded in the data, and the routing identifier is used by the constellation of SkyRouter router satellites to route the data to the ground terminal.

12. A satellite communication method, comprising:
sending data from a UserSat satellite to a constellation of SkyRouter router satellites via a two-way high-speed data connection, the UserSat satellite in orbit between the constellation of SkyRouter router satellites and Earth;
sending the data from the constellation of SkyRouter router satellites to at least one ground terminal; and
sending the data from the ground terminal to a ground-based computing device.

13. The method of claim 12, wherein the UserSat satellite is a Medium Earth Orbit (MEO) satellite.

14. The method of claim 12, wherein the UserSat satellite is a Low Earth Orbit (LEO) satellite.

15. The method of claim 12, wherein the two-way high-speed data connection is established according to an Internet Protocol.

16. The method of claim 12, further comprising sending the data from a first one of the SkyRouter router satellites to a second one of the SkyRouter router satellites before sending the data from the constellation of SkyRouter router satellites to the ground terminal.

17. The method of claim 12, wherein sending data from the UserSat satellite to the constellation of SkyRouter router satellites via the two-way high-speed data connection comprises sending the data over a space-to-space data link toward the constellation of SkyRouter router satellites.

18. The method of claim 17, wherein the UserSat satellite is assigned an Internet Protocol (IP) address, the method further comprising receiving data from the constellation of SkyRouter router satellites at the UserSat satellite via the IP address.

19. The method of claim 18, further comprising embedding a routing identifier in the data.

20. The method of claim 19, further comprising scheduling, by the UserSat satellite or the ground terminal, computing or data storage services on one or more of SkyRouter router satellites.
